(19) United States
(12) Patent Application Publication
(10) Pub. No.: US 2016/0279896 A1
(43) Pub. Date: Sep. 29, 2016

(54) THERMOPLASTIC COMPOSITE AND ITS MANUFACTURING

(71) Applicants: BAYER MATERIALSCIENCE LLC, Pittsburgh, PA (US); BAYER MATERIALSCIENCE TAIWAN LTD., Taipei (TW); COMPLAM MATERIAL CO., LTD., Taichung City (TW)

(72) Inventors: Zhizong Liu, Wilbraham, MA (US); Hsu-Ching Chang, Taipei City 116 (TW); Szesu Soong, Taipei 11652 (TW)

(21) Appl. No.: 14/442,535

(22) PCT Filed: Nov. 14, 2013
(86) PCT No.: PCT/US2013/070037

§ 371 Date: May 13, 2015

Related U.S. Application Data
(60) Provisional application No. 61/731,632, filed on Nov. 30, 2012.
(60) Provisional application No. 61/727,273, filed on Nov. 16, 2012.

(51) Int. Cl. B32B 5/02; B32B 27/30; B32B 27/32; B32B 37/15; B32B 27/40; B32B 37/04; B32B 37/10; B32B 27/12; B32B 27/36

(52) U.S. Cl. CPC B32B 5/024; B32B 27/12; B32B 27/302; B32B 27/32; B32B 27/36; B32B 27/365; B32B 27/40; B32B 37/04; B32B 37/1027; B32B 37/153; B32B 2262/0261; B32B 2262/0269; B32B 2262/08; B32B 2262/101; B32B 2262/105; B32B 2262/106; B32B 2305/18; B32B 2307/75; B32B 2398/20

(57) ABSTRACT

The present invention provides a roll-to-roll continuous manufacturing process for producing a thermoplastic composite laminate comprising extruding a thermoplastic resin into a film article, surface treating a woven fiber cloth material with a thermoplastic sizing and laminating at least one layer of thermoplastic film and at least one layer of the surfaced treated fiber cloth material into a composite sheet at a temperature above the melting or softening point of the thermoplastic film and under pressure applied by nipping rolls or nipping belts.

### RELATED APPLICATIONS

This application claims the benefit, under 35 USC §119(e), of U.S. Provisional Application No. 61/727,273 filed Nov. 16, 2012 entitled “THERMOPLASTIC COMPOSITE AND ITS MANUFACTURING” and 61/731,632 filed Nov. 30, 2012 entitled “THERMOPLASTIC COMPOSITE AND ITS MANUFACTURING”, the entireties of which are incorporated herein by reference.

### FIELD OF THE INVENTION

The present invention is directed in general to thermoplastic polymers and in particular to methods of producing thermoplastic composites.

### BACKGROUND OF THE INVENTION

Edwards, in U.S. Published Patent Application No. 2002/0094427 describes a reinforced thermoplastic article comprising a) a first thermoplastic layer; and b) a fiber-reinforced thermoplastic composite that contains a thermoplastic resin and a plurality of continuous reinforcing fibers impregnated with the resin, wherein the first thermoplastic layer is thermoformed or blow-molded to the thermoplastic composite.

U.S. Published Patent Application No. 2008/0160281 in the name of Vickery et al., provides a composition for a reinforcing fiber used to reinforce thermoset resins comprising: at least one silane coupling agent; and one or more film forming agents, wherein said composition is free of any additives that are typically included in conventional sizing applications to impose desired properties or characteristics to the size composition.

Larson et al., in U.S. Published Patent Application No. 2008/0233364 detail a dimensionally stable continuous laminate structure comprising: a reinforcement layer comprising, by weight, from about 20% to about 80% fiber reinforcement and from about 80% to about 20% thermoset polymer selected from polyester, phenolic, epoxy and mixtures thereof; a surface layer comprising a substrate layer and a decorative layer, the substrate layer comprising, by weight, from about 20% to 80% by weight fiber reinforcement and from about 80% to about 20% polymer selected from polyvinyl chloride, polyester, phenolic, epoxy and mixtures thereof, and the decorative layer comprising at least one of polyvinyl chloride, acrylic, and polyurethane; an adhesive layer disposed between the reinforcement layer and the substrate layer of the surface layer; an adhesive primer layer disposed between the reinforcement layer and the adhesive layer, wherein the adhesive primer is of a material composition different than the adhesive layer.

U.S. Published Patent Application No. 2012/0061013 in the name of Kubota et al. discloses a composite article and a process for manufacturing the composite article. The composite article comprises multiple layers including high tenacity fibers incorporated into a fabric and a core thermoplastic resin. The fabric may be coated with a surface treatment agent and a polymer matrix resin. Single or multiple layers of the composite articles may be formed into a composite part said to have high strength, rigidity, fast molding cycle time and extremely good conformability in a 3-dimensional mold. The composite parts formed by the process of Kubota et al. are said to have high part strength in all directions.

Schleiermacher et al., in U.S. Published Patent Application No. 2012/0148803 teach a long fiber reinforced polyurethane molded part which has three-dimensional raised structures, especially ribs, struts and/or domes, characterized by further containing short fibers in addition to said long fibers, wherein the weight ratio of short fibers and/or plate-like fillers to the fiber-free polyurethane matrix in a volume of ribs, struts and/or domes is higher than the weight ratio of short fibers and/or plate-like fillers to the fiber-free polyurethane matrix in two-dimensional areas outside the raised structures.

U.S. Published Patent Application No. 2012/0156376 in the name of Kim et al. describes method for manufacturing a composite molded body, and more particularly, a method for manufacturing a composite molded body, comprising: a step of manufacturing a molded body containing polyethylene terephthalate, acrylonitrile-butadiene-styrene, and glass or carbon fibers; and a step of coating the molded body with a reactive polyurethane composition or with a rubber composition. The composite molded body can be used in lieu of a wheel hub casting to minimize the weight of a wheel, can be manufactured at a low cost in terms of materials, and can be mass-produced. The composite molded body is said to have remarkably superior adhesion to the coating composition, and the strength and durability thereof corresponds to that of cast metal such as cast iron, stainless steel, aluminum, etc.

Cheng, in U.S. Published Patent Application No. 2012/0177927 provides a method for making a molded carbon fiber prepreg which includes the steps of: (a) thermocompressing a pristine carbon fiber prepreg that includes a carbon fiber substrate and a matrix resin impregnated into the carbon fiber substrate, and a thermoplastic material at an elevated temperature such that the thermoplastic material and the matrix resin of the pristine carbon fiber prepreg are subjected to a crosslinking reaction so as to form a crosslinked thermoplastic layer on the pristine carbon fiber prepreg; and (b) injection molding a thermoplastic elastomer onto the crosslinked thermoplastic layer.

U.S. Published Patent Application No. 2013/0252059 in the name of Choi et al., discloses a battery pack case assembly for an electric or hybrid vehicle and a method for manufacturing the same. The battery pack case assembly includes a case body and a cover. The case body receives a battery pack, and the cover is coupled to the case body. The case body is formed of a plastic composite in which a long fiber or a blend of a long fiber and a continuous fiber is used as a reinforcing fiber in a plastic matrix. A separate reinforced member is bonded to both side bracket parts for coupling to a vehicle body, and is formed of a plastic composite in which a long fiber, a continuous, or a blend of a long fiber and a continuous fiber is used as the reinforcing fiber in the plastic matrix.

There continues to be a need in the art for new manufacturing process for producing thermoplastic composite laminates.

### SUMMARY OF THE INVENTION

Accordingly, the present invention provides such a roll-to-roll continuous manufacturing process for producing thermoplastic composite laminates. A thermoplastic polyurethane resin optionally having soft segments in its backbone structure is extruded into a film article by either blown film or flat-die process. A silane coupling agent is optionally added in the thermoplastic film. A woven fiber cloth material is surfaced treated with a polymer based sizing, and optional silane coupling agent is added. At least one layer of thermoplastic film and at least one layer of the surfaced treated fiber cloth material are laminated into composite sheets under temperatures above the melting or softening point of the thermoplastic film and under pressure that is applied by nipping rolls or nipping belts. A continuous roll-to-roll lamination process realized in the above described way can produce thermoplastic composite sheets using rolls of fiber cloth and thermoplastic film materials.

The resulting thermoplastic/fiber composite sheets can be used to make parts by thermoforming in short molding cycles and are recyclable. These parts possess good chemical resistance, mechanical properties and are paintable or printable without priming or other surface preparations.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows thermoplastic composites processing with films;

FIG. 2 demonstrates thermoplastic composites processing with pre-pregs;

FIGS. 3A, 3B and 3C illustrate three processes for forming or molding thermoplastic composites: a batch process (FIG. 3A), a semi-continuous process (FIG. 3B) and a continuous process (FIG. 3C);

FIG. 4A shows layer structure and thermoforming conditions for a TPU film and PC/ABS film using glass fiber A;

FIG. 4B shows layer structure and thermoforming conditions for a TPU film and PC/ABS film using glass fiber B;

FIG. 5 is a photograph illustrating the data of Table I for a thermoplastic polyurethane/glass fiber laminate treated with the various sizings.

### DETAILED DESCRIPTION OF THE INVENTION

The present invention will now be described for purposes of illustration and not limitation. Except in the operating examples, or where otherwise indicated, all numbers expressing quantities, percentages, OH numbers, functionalities and so forth in the specification are to be understood as being modified in all instances by the term “about.” Equivalent weights and molecular weights given herein in Daltons (Da) are number average equivalent weights and number average molecular weights respectively, unless indicated otherwise.

Thermoplastic films suitable for use in the present invention as a substrate for the thermoplastic composite sheet include, without limitation, polyethylene terephthalate glycol-modified (PETG), TRITAN copolyester, polycarbonate (PC), poly(methyl methacrylate) (PMMA), polyacrylonitrile-co-butadiene-co-styrene (ABS), polycarbonate/acrylonitrile butadiene styrene (PC/ABS) blend and polystyrene (PS). Both flame retardant and non-flame retardant grades of the thermoplastic films are suitable for use in the present invention.

The thermoplastic films preferably will have a high enough melt flowability, above 200° C., for the inventive composite lamination process. Preferably, the melt flow index of the extruded film tested at 210° C. and under 8.7 kg is above 2 g/10 min., more preferably between 5 g/10 min. and 60 g/10 min. and most preferably from 20 g/10 min. and 40 g/10 min.

The films also are preferably amorphous or with very low crystallinity, and preferably have a glass transition temperature lower than 170° C., more preferably from 70 to 160° C. When the continuous fiber reinforced sheet composite made of the above plastic films is thermoformed, the amorphous feature of the polymer substrate can significantly reduce the forming cycle time and warping of final parts.

Suitable polycarbonate resins for preparing thermoplastic films useful in the present invention are homopolycarbonates and copolycarbonates, both linear or branched resins and mixtures thereof.

The polycarbonates have a weight average molecular weight of preferably 10,000 to 200,000, more preferably 20,000 to 80,000 and their melt flow rate, per ASTM D-1238 at 300° C., is preferably 1 to 65 g/10 min., more preferably 2 to 35 g/10 min. They may be prepared, for example, by the known diphasic interface process from a carbonic acid derivative such as phosgene and dihydroxy compounds by polycondensation (See, German Offenlegungsschriften 2,063,050; 2,063,052; 1,570,703; 2,211,956; 2,211,957 and 2,248,817; French Patent 1,561,518; and the monograph by H. Schnell, “Chemistry and Physics of Polycarbonates”, Interscience Publishers, New York, N.Y., 1964).

In the present context, dihydroxy compounds suitable for the preparation of the polycarbonates of the invention conform to the structural formulae (1) or (2) below.

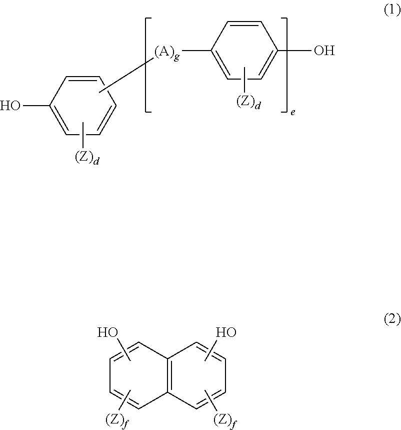

wherein

A denotes an alkylene group with 1 to 8 carbon atoms, an alkylidene group with 2 to 8 carbon atoms, a cycloalkylene group with 5 to 15 carbon atoms, a cycloalkylidene group with 5 to 15 carbon atoms, a carbonyl group, an oxygen atom, a sulfur atom, —SO— or —SO₂ or a radical conforming to

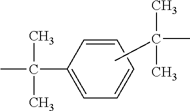

e and g both denote the number 0 to 1;

Z denotes F, Cl, Br or C₁-C₄-alkyl and if several Z radicals are substituents in one aryl radical, they may be identical or different from one another;

d denotes an integer of from 0 to 4; and

f denotes an integer of from 0 to 3.

Among the dihydroxy compounds useful in the practice of the invention are hydroquinone, resorcinol, bis-(hydroxyphenyl)-alkanes, bis-(hydroxy-phenyl)-ethers, bis-(hydroxyphenyl)-ketones, bis-(hydroxy-phenyl)-sulfoxides, bis-(hydroxyphenyl)-sulfides, bis-(hydroxyphenyl)-sulfones, and α,α-bis-(hydroxyphenyl)-diisopropylbenzenes, as well as their nuclear-alkylated compounds. These and further suitable aromatic dihydroxy compounds are described, for example, in U.S. Pat. Nos. 5,401,826, 5,105,004; 5,126,428; 5,109,076; 5,104,723; 5,086,157; 3,028,356; 2,999,835; 3,148,172; 2,991,273; 3,271,367; and 2,999,846, the contents of which are incorporated herein by reference.

Further examples of suitable bisphenols are 2,2-bis-(4-hydroxyphenyl)-propane (bisphenol A), 2,4-bis-(4-hydroxyphenyl)-2-methyl-butane, 1,1-bis-(4-hydroxyphenyl)-cyclohexane, α,α′-bis-(4-hydroxy-phenyl)-p-diisopropylbenzene, 2,2-bis-(3-methyl-4-hydroxyphenyl)-propane, 2,2-bis-(3-chloro-4-hydroxyphenyl)-propane, 4,4′-dihydroxy-diphenyl, bis-(3,5-dimethyl-4-hydroxyphenyl)-methane, 2,2-bis-(3,5-dimethyl-4-hydroxyphenyl)-propane, bis-(3,5-dimethyl-4-hydroxyphenyl)-sulfide, bis-(3,5-dimethyl-4-hydroxy-phenyl)-sulfoxide, bis-(3,5-dimethyl-4-hydroxyphenye-sulfone, dihydroxy-benzophenone, 2,4-bis-(3,5-dimethyl-4-hydroxyphenyl)-cyclohexane, α,α′-bis-(3,5-dimethyl-4-hydroxyphenyl)-p-diisopropyl-benzene and 4,4′-sulfonyl diphenol.

Examples of particularly preferred aromatic bisphenols are 2,2-bis-(4-hydroxyphenyl)-propane, 2,2-bis-(3,5-dimethyl-4-hydroxyphenye-propane, 1,1-bis-(4-hydroxyphenyl)-cyclohexane and 1,1-bis-(4-hydroxy-phenyl)-3,3,5-trimethylcyclohexane. The most preferred bisphenol is 2,2-bis-(4-hydroxyphenyl)-propane (bisphenol A).

The polycarbonates of the invention may entail in their structure units derived from one or more of the suitable bisphenols.

Among the resins suitable in the practice of the invention are phenolphthalein-based polycarbonate, copolycarbonates and terpoly-carbonates such as are described in U.S. Pat. Nos. 3,036,036 and 4,210,741, both of which are incorporated by reference herein.

The polycarbonates of the invention may also be branched by condensing therein small quantities, e.g., 0.05 to 2.0 mol % (relative to the bisphenols) of polyhydroxyl compounds. Polycarbonates of this type have been described, for example, in German Offenlegungsschriften 1,570,533; 2,116,974 and 2,113,374; British Patents 885,442 and 1,079,821 and U.S. Pat. No. 3,544,514, which is incorporated herein by reference. The following are some examples of polyhydroxyl compounds which may be used for this purpose: phloroglucinol; 4,6-dimethyl-2,4,6-tri-(4-hydroxy-phenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-(4,4′-dihydroxydiphenyl)]-cyclohexyl-propane; 2,4-bis-(4-hydroxy-1-isopropylidine)-phenol; 2,6-bis-(2′-dihydroxy-5′-methylbenzyl)-4-methyl-phenol; 2,4-dihydroxybenzoic acid; 2-(4-hydroxy-phenyl)-2-(2,4-dihydroxy-phenyl)-propane and 1,4-bis-(4,4′-dihydroxytri-phenylmethyl)-benzene. Some of the other polyfunctional compounds are 2,4-dihydroxy-benzoic acid, trimesic acid, cyanuric chloride and 3,3-bis-(4-hydroxyphenyl)-2-oxo-2,3-dihydroindole.

In addition to the polycondensation process mentioned above, other processes for the preparation of the polycarbonates of the invention are polycondensation in a homogeneous phase and transesterification. The suitable processes are disclosed in U.S. Pat. Nos. 3,028,365; 2,999,846; 3,153,008; and 2,991,273 which are incorporated herein by reference.

The preferred process for the preparation of polycarbonates is the interfacial polycondensation process. Other methods of synthesis in forming the polycarbonates of the invention, such as disclosed in U.S. Pat. No. 3,912,688, incorporated herein by reference, may be used. Suitable polycarbonate resins are available in commerce, for instance, from Bayer MaterialScience under the MAKROLON trademark. The polycarbonate is present in the thermoplastic blend in from preferably 50 to 70% by weight of the combined weights of the thermoplastic aromatic polycarbonate and thermoplastic polyurethane present.

Aliphatic thermoplastic polyurethanes are particularly preferred in the methods of the present invention such as those prepared according to U.S. Pat. No. 6,518,389, the entire contents of which are incorporated herein by reference.

Thermoplastic polyurethane elastomers are well known to those skilled in the art. They are of commercial importance due to their combination of high-grade mechanical properties with the known advantages of cost-effective thermoplastic processability. A wide range of variation in their mechanical properties can be achieved by the use of different chemical synthesis components. A review of thermoplastic polyurethanes, their properties and applications is given in Kunststoffe [Plastics] 68 (1978), pages 819 to 825, and in Kautschuk, Gummi, Kunststoffe [Natural and Vulcanized Rubber and Plastics] 35 (1982), pages 568 to 584.

Thermoplastic polyurethanes are synthesized from linear polyols, mainly polyester diols or polyether diols, organic diisocyanates and short chain diols (chain extenders). Catalysts may be added to the reaction to speed up the reaction of the components.

The relative amounts of the components may be varied over a wide range of molar ratios in order to adjust the properties. Molar ratios of polyols to chain extenders from 1:1 to 1:12 have been reported. These result in products with hardness values ranging from 80 Shore A to 85 Shore D.

Thermoplastic polyurethanes can be produced either in stages (prepolymer method) or by the simultaneous reaction of all the components in one step (one shot). In the former, a prepolymer formed from the polyol and diisocyanate is first formed and then reacted with the chain extender. Thermoplastic polyurethanes may be produced continuously or batch-wise. The best-known industrial production processes are the so-called belt process and the extruder process.

Examples of the suitable polyols include difunctional polyether polyols, polyester polyols, and polycarbonate polyols. Small amounts of trifunctional polyols may be used, yet care must be taken to make certain that the thermoplasticity of the thermoplastic polyurethane remains substantially un-effected.

Suitable polyester polyols include the ones which are prepared by polymerizing ε-caprolactone using an initiator such as ethylene glycol, ethanolamine and the like. Further suitable examples are those prepared by esterification of polycarboxylic acids. The polycarboxylic acids may be aliphatic, cycloaliphatic, aromatic and/or heterocyclic and they may be substituted, e.g., by halogen atoms, and/or unsaturated. The following are mentioned as examples: succinic acid; adipic acid; suberic acid; azelaic acid; sebacic acid; phthalic acid; isophthalic acid; trimellitic acid; phthalic acid anhydride; tetrahydrophthalic acid anhydride; hexahydrophthalic acid anhydride; tetrachlorophthalic acid anhydride, endomethylene tetrahydrophthalic acid anhydride; glutaric acid anhydride; maleic acid; maleic acid anhydride; fumaric acid; dimeric and trimeric fatty acids such as oleic acid, which may be mixed with monomeric fatty acids; dimethyl terephthalates and bis-glycol terephthalate. Suitable polyhydric alcohols include, e.g., ethylene glycol; propylene glycol-(1,2) and -(1,3); butylene glycol-(1,4) and -(1,3); hexanediol-(1,6); octanediol-(1,8); neopentyl glycol; (1,4-bis-hydroxy-methylcyclohexane); 2-methyl-1,3-propanediol; 2,2,4-tri-methyl-1,3-pentanediol; triethylene glycol; tetraethylene glycol; polyethylene glycol; dipropylene glycol; polypropylene glycol; dibutylene glycol and polybutylene glycol, glycerine and trimethlyolpropane.

Suitable polyisocyanates for producing the thermoplastic polyurethanes useful in the present invention may be, for example, organic aliphatic diisocyanates including, for example, 1,4-tetramethylene diisocyanate, 1,6-hexamethylene diisocyanate, 2,2,4-trimethyl-1,6-hexamethylene diisocyanate, 1,12-dodecamethylene diisocyanate, cyclohexane-1,3- and -1,4-diisocyanate, 1-isocyanato-2-isocyanatomethyl cyclopentane, 1-isocyanato-3-isocyanatomethyl-3,5,5-trimethyl-cyclohexane (isophorone diisocyanate or IPDI), bis-(4-isocyanatocyclohexyl)-methane, 2,4′-dicyclohexylmethane diisocyanate, 1,3- and 1,4-bis-(isocyanatomethyl)-cyclohexane, bis-(4-isocyanato-3-methylcyclohexyl)-methane, α,α,α′,α′-tetramethyl-1,3- and/or -1,4-xylylene diisocyanate, 1-isocyanato-1-methyl-4(3)-isocyanatomethyl cyclohexane, 2,4- and/or 2,6-hexahydrotoluylene diisocyanate, and mixtures thereof.

Preferred chain extenders with molecular weights of 62 to 500 include aliphatic diols containing 2 to 14 carbon atoms, such as ethanediol, 1,6-hexanediol, diethylene glycol, dipropylene glycol, and 1,4-butanediol in particular, for example. However, diesters of terephthalic acid with glycols containing 2 to 4 carbon atoms are also suitable, such as terephthalic acid-bis-ethylene glycol or -1,4-butanediol for example, or hydroxyalkyl ethers of hydroquinone, such as 1,4-di-(β-hydroxyethyl)-hydroquinone for example, or (cyclo)aliphatic diamines, such as isophorone diamine, 1,2- and 1,3-propylenediamine, N-methyl-propylenediamine-1,3 or N,N′-dimethyl-ethylenediamine, for example, and aromatic diamines, such as toluene 2,4- and 2,6-diamines, 3,5-diethyltoluene 2,4- and/or 2,6-diamine, and primary ortho-, di-, tri- and/or tetraalkyl-substituted 4,4′-diaminodiphenylmethanes, for example. Mixtures of the aforementioned chain extenders may also be used. Optionally, triol chain extenders having a molecular weight of 62 to 500 may also be used. Moreover, customary monofunctional compounds may also be used in small amounts, e.g., as chain terminators or demolding agents. Alcohols such as octanol and stearyl alcohol or amines such as butylamine and stearylamine may be cited as examples.

To prepare the thermoplastic polyurethanes, the synthesis components may be reacted, optionally in the presence of catalysts, auxiliary agents and/or additives, in amounts such that the equivalent ratio of NCO groups to the sum of the groups which react with NCO, particularly the OH groups of the low molecular weight diols/triols and polyols, is 0.9:1.0 to 1.2:1.0, preferably 0.95:1.0 to 1.10:1.0.

Suitable catalysts include tertiary amines which are known in the art, such as triethylamine, dimethyl-cyclohexylamine, N-methylmorpholine, N,N′-dimethyl-piperazine, 2-(dimethyl-aminoethoxy)-ethanol, diazabicyclo-(2,2,2)-octane and the like, for example, as well as organic metal compounds in particular, such as titanic acid esters, iron compounds, tin compounds, e.g., tin diacetate, tin dioctoate, tin dilaurate or the dialkyltin salts of aliphatic carboxylic acids such as dibutyltin diacetate, dibutyltin dilaurate or the like. The preferred catalysts are organic metal compounds, particularly titanic acid esters and iron and/or tin compounds.

In addition to difunctional chain extenders, small quantities of up to about 5 mol. %, based on moles of the bifunctional chain extender used, of trifunctional or more than trifunctional chain extenders may also be used.

Trifunctional or more than trifunctional chain extenders of the type in question are, for example, glycerol, trimethylolpropane, hexanetriol, pentaerythritol and triethanolamine.

Suitable thermoplastic polyurethanes are available in commerce, for instance, from Bayer MaterialScience under the TEXIN trademark, from BASF under the ELASTOLLAN trademark and from Lubrizol under the trade names of ESTANE and PELLETHANE.

Many different fibers or strands and combinations may be utilized in the practice of the present invention, including but not limited to glass, rock, ceramic, carbon, graphite, polyamide, aramid (NOMEX, KEVLAR), wool and cotton fibers of other organic and inorganic materials. Various metallic fibers such as copper and aluminum may also be utilized in various proportions with non-metallic fibers. The fibers amount to 20% to 60%, more preferably 35% to 60%, and most preferably 45% to 55% by volume of the composite.

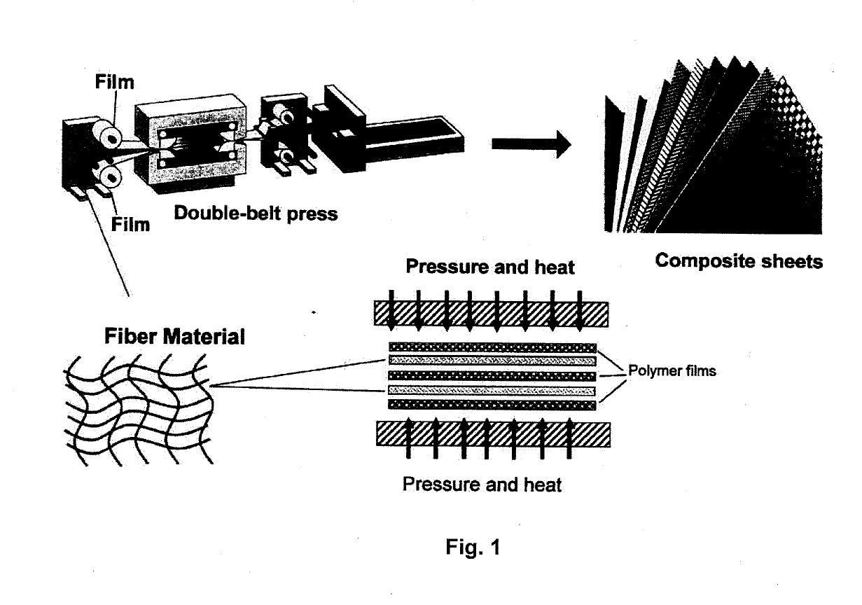

FIG. 1 shows thermoplastic composites processing with films. As can be appreciated by reference to FIG. 1, at least one layer of thermoplastic film and one layer of fiber cloth are unwound from their individual rolls and guided to meet in a laminator comprising of heated nip rolls and nipping belts. Under pressure and heat applied by the nipping rolls and belts, the thermoplastic film layers turn into a melt and are squeezed to fill into all voids inside the fiber clothing material as the laminating layers moving forward continuously inside the laminator. Upon exiting the laminator, the laminate is cooled to below melting or glass transition temperature of the thermoplastic film by passing through cooling rolls and consolidates into a rigid composite sheet. The resultant composite sheet is wound up into a roll for further forming and molding uses.

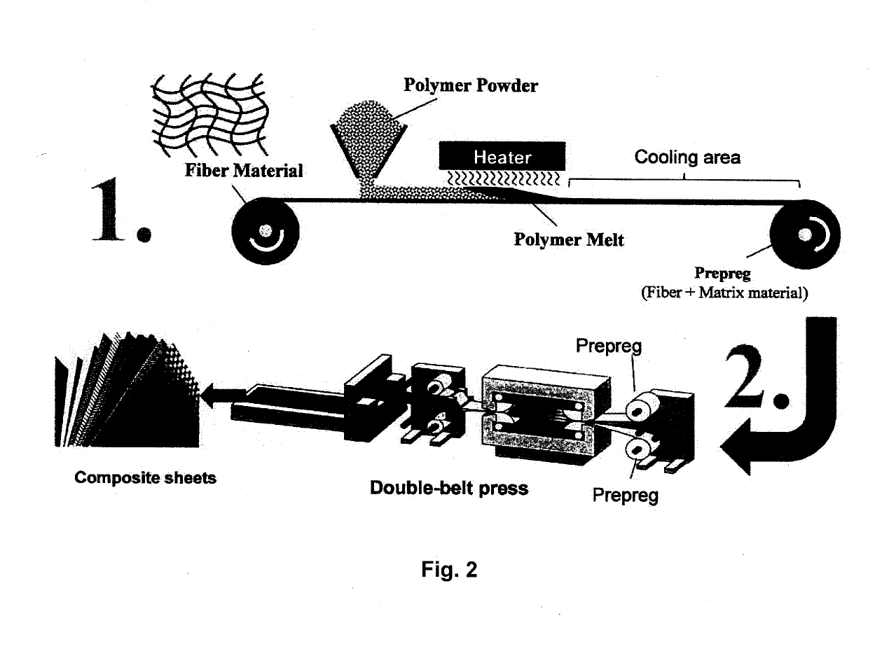

FIG. 2 illustrates thermoplastic composites processing with pre-pregs. As can be appreciated by reference to FIG. 2, fiber cloth is unwound from a roll and fine powder of a thermoplastic material is uniformly sputtered onto the fiber cloth web so that the volume fraction of the fiber material is about 40-50%. The fiber cloth with thermoplastic power on top of it is then heated while passing through an oven, so that the thermoplastic powder will melt and be fused into a continuous layer on top of the fiber cloth. A fiber cloth pre-preg is thus formed and subsequently cooled and wound into pre-preg rolls. At least two fiber cloth pre-preg rolls are unwound continuously and guided to meet in a laminator containing heated nip rolls and nipping belts. Under pressure and heat applied by the nipping rolls and belts, the thermoplastic in the fiber cloth pre-preg turns into a melt and is squeezed to fill into all voids inside the fiber clothing material. Upon exiting the laminator, the laminate is cooled to below melting or glass transition temperature of the thermoplastic film by passing through cooling rolls and consolidates into rigid composite sheet. The composite sheet is wound into a roll for further forming and molding uses.

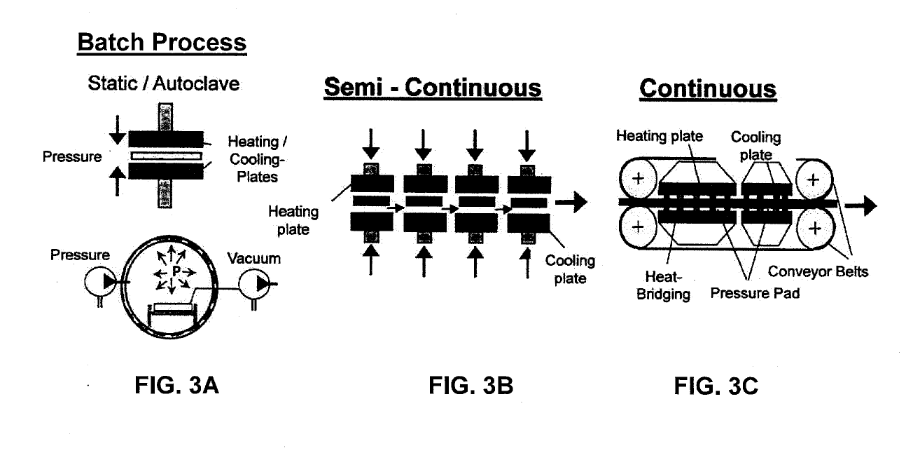

FIGS. 3A, 3B and 3C illustrate three processes for forming or molding thermoplastic composites: a batch process, a semi-continuous process and a continuous process. As can be appreciated by reference to FIG. 3A, the batch process involves cutting thermoplastic film and fiber cloth into certain size sheets, then stacking layers of the sheets and using a static hot press or an auto clave to melt thermoplastic film and fuse the discrete fiber cloth and polymer layers together. Preferably, one composite sheet is made in one processing cycle. In a semi-continuous process shown in FIG. 3B, the fiber cloth and thermoplastic film are intermittently unwound and stacked together and guided to enter into a hot press to melt and fuse the fiber cloth and thermoplastic material together and then cooled and trimmed into individual composite sheets. In the continuous process thermoplastic depicted in FIG. 3C, film and fiber cloth rolls are continuously unwound and stacked and then laminated by heated nip rolls and belts under pressure, the laminate is then cooled and wound into rolls.

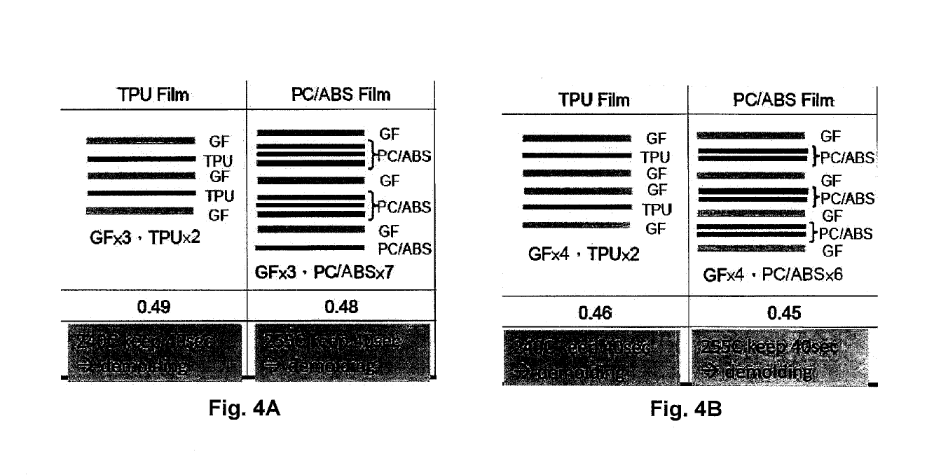

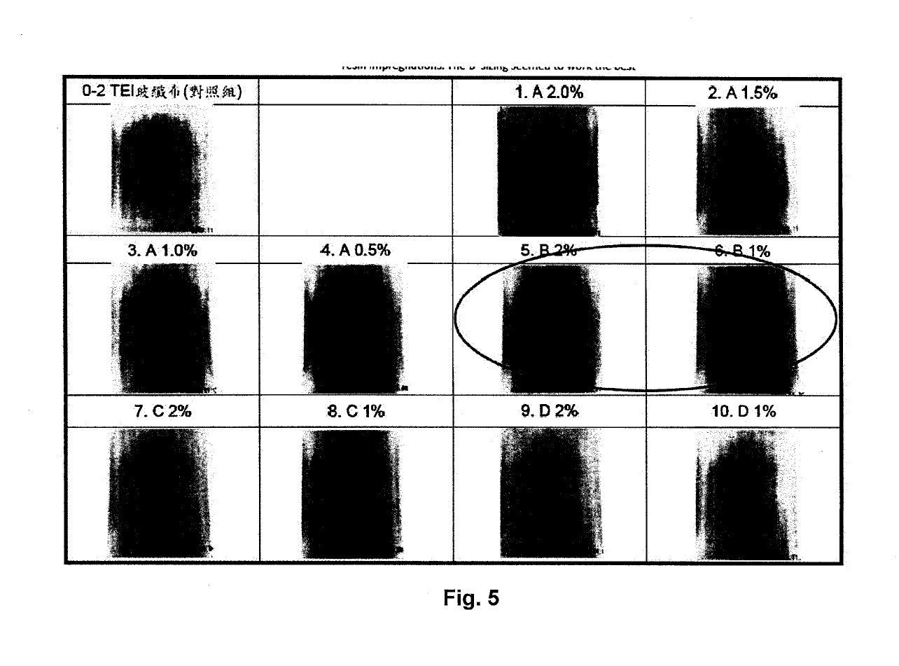

FIG. 4A shows layer structure and thermoforming conditions for a TPU film and PC/ABS film based composite using glass fiber cloth A, whose base weight is at 208 g/m². As can be appreciated by reference to FIG. 4A, using the continuous roll to roll process, a glass fiber/TPU composite material was made by stacking and laminating three layers of glass fiber A and two layers of 84 Shore D TPU film at 10 mil, producing a composite with a fiber volume fraction at about 49% and a total gauge of 0.9 mm. This composite sheet may be thermoformed into tablet housing shown in FIG. 5 at 240° C. for only 40 seconds. Using the same continuous roll to roll process, glass fiber/PC/ABS blend composite was made by stacking and laminating three layers of glass fiber cloth A and seven layers of PC/ABS blend film, producing a composite with a fiber volume fraction at about 48% and a total gauge of 0.9 mm. This composite sheet may be thermoformed into tablet housing as indicated in FIG. 5 at 255° C. for only 40 seconds.

FIG. 4B shows layer structure and thermoforming conditions for a TPU film and PC/ABS film based composite with glass fiber B, whose base weight is 140 g/m². As can be appreciated by reference to FIG. 4B, using the continuous roll to roll process, a glass fiber/TPU composite material was made by stacking and laminating four layers of glass fiber cloth B and two layers of 84 Shore D TPU film at 10 mil together, producing a composite with a fiber volume fraction at about 46% and a total gauge of 0.85 mm. This composite sheet may be thermoformed into a tablet housing at 240° C. for only 40 seconds. Using the same continuous roll to roll process, a glass fiber/PC/ABS blend composite was made by stacking and laminating four layers of glass fiber cloth B and six layers of PC/ABS blend film, resulting in a composite with a fiber volume fraction at about 45% and a total gauge of 0.85 mm. This composite sheet may be thermoformed into tablet housing as indicated in FIG. 5 at 255° C. for only 40 seconds.

### Examples

The present invention is further illustrated, but is not to be limited, by the following examples in which the following materials were used:

TPU a thermoplastic polyurethane film (10 mil thickness) available from Bayer MaterialScience as DURAFLEX X-2311, 84 Shore D, base weight of 320 g/m²;

PC/ABS a polycarbonate/acrylonitrile-butadiene-styrene blend available from Chilin Tech, base weight of 95 g/m²;

Sizing A a polyester based non-reactive polyurethane water-borne dispersion (PUD) available from Bayer MaterialScience mixed with 1 wt. % gamma-aminopropyltriethoxysilane;

Sizing B a polyester based reactive water-borne PUD available from Bayer MaterialScience mixed with 1 wt. % gamma-aminopropyltriethoxysilane;

Sizing C a polyester based non-reactive water-borne PUD available from Bayer MaterialScience mixed with 1 wt. % vinylbenzylamine silane;

Sizing D is a polyester based reactive water-borne PUD available from Bayer MaterialScience mixed with 1 wt. % vinylbenzylamine silane;

Glass fiber A glass fiber cloth having a base weight of 208 g/m² commercially available from Nan Ya Plastics;

Glass fiber B glass fiber cloth having a base weight of 140 g/m² commercially available from TEI.

Laminates were made according to the process of the present invention and the flexural modulus and tensile strengths were determined. Flexural modulus was determined at 30° C. by dynamic mechanical analysis (DMA). Tensile strength was determined by ASTM D3039 and is reported for machine direction (MD) and cross machine direction (CD) below in Table I.

TABLE I

| | | TPU/Glass | | | PC/ABS/Glass | | |
|---|---|---|---|---|---|---|---|
| | | Fiber laminate | | | Fiber laminate | | |
| | | Flexural | Tensile | Tensile | Flexural | Tensile | Tensile |
| | | Modu- | strength | strength | Modu- | strength | strength |
| | Sizing | lus | (MPa) | (MPa) | lus | (MPa) | (MPa) |
| Ex. | material | (GPa) | MD | CD | (GPa) | MD | CD |
| C | None | 6.69 | 141.2 | 136.4 | 6.55 | 146.3 | 154.2 |
| 1 | A (2.0%) | 6.95 | 196.6 | 166.1 | 6.21 | 176.5 | 224.1 |
| 2 | A (1.5%) | 4.67 | 228.3 | 160.9 | 6.55 | 163.0 | 231.3 |
| 3 | A (1.0%) | 7.92 | 209.7 | 180.9 | 5.67 | 180.8 | 194.4 |
| 4 | A (0.5%) | 7.13 | 203.8 | 163.9 | 6.58 | 234.2 | 171.1 |
| 5 | B (2.0%) | 7.68 | 207.6 | 186.2 | 5.30 | 212.6 | 178.2 |
| 6 | B (1.0%) | 8.73 | 231.9 | 200.2 | 7.27 | 237.9 | 170.0 |
| 7 | C (2.0%) | 8.29 | 221.5 | 207.1 | 6.64 | 212.1 | 173.4 |
| 8 | C (1.0%) | 5.72 | 252.2 | 177.8 | 7.43 | 210.5 | 192.6 |
| 9 | D (2.0%) | 4.29 | 237.0 | 185.9 | 7.45 | 204.9 | 155.6 |
| 10 | D (1.0%) | 6.83 | 232.1 | 148.7 | 5.88 | 212.7 | 191.0 |

FIG. 5 is a photograph illustrating the data in Table I for a TPU/glass fiber laminate treated with the various sizings. As can be appreciated by reference to FIG. 5, the TPU penetrated best into the glass fibers with sizing B at both 1.0% and 2.0% concentrations. The laminates of these two examples (Ex. 5 and Ex. 6) had the best combination of flexural modulus and tensile strength.

The thermoplastic/fiber composite sheets made by the instant process may preferably be used to make parts by thermoforming in short molding cycles and are recyclable. These parts possess good chemical resistance, mechanical properties and are paintable or printable without priming or other surface preparations.

Various aspects of the subject matter described herein are set out in the following numbered clauses in any combination thereof:

1. A roll-to-roll continuous manufacturing process for producing a thermoplastic composite laminate comprising: extruding a thermoplastic resin into a film article; surface treating a woven fiber cloth material with a polymer sizing; and laminating at least one layer of thermoplastic film and at least one layer of the surfaced treated fiber cloth material into a composite sheet at a temperature above the melting or softening point of the thermoplastic film and under pressure applied by nipping rolls or nipping belts.

2. The process according to claim 1 further including adding a silane coupling agent to the thermoplastic film.

3. The process according to claim 1 further including adding a silane coupling agent to the polymer sizing.

4. The process according to claim 1, wherein the extruding is by one selected from the group consisting of a blown film process and a flat-die process.

5. The process according to claim 1, wherein the thermoplastic resin is selected from the group consisting of thermoplastic polyurethane, polyethylene terephthalate glycol-modified copolyester, polycarbonate, poly(methyl methacrylate), polycarbonate/acrylonitrile butadiene styrene blend and polystyrene.

6. The process according to claim 1, wherein the thermoplastic resin is polyurethane.

7. The process according to claim 6, wherein the polyurethane has soft segments in its backbone structure and hardness between 50-80 Shore D.

8. The process according to claim 6, wherein the polyurethane has no soft segments in its backbone structure and has a hardness above 80 Shore D.

9. The process according to claim 1, wherein the polymer sizing is selected from the group consisting of polyurethane, epoxy, phenolic and polyacrylate based dispersion in water or an organic solvent.

10. The process according to claim 1, wherein the polymer sizing is a dispersion of polyurethane in water.

11. The process according to claim 1, wherein the fibers are selected from the group consisting of glass, rock, ceramic, carbon, graphite, polyamide, aramid, wool cotton, copper and aluminum and combinations thereof.

12. A thermoplastic composite laminate made according to the process of claim 1.

13. An article made of the thermoplastic laminate according to claim 12.

The foregoing examples of the present invention are offered for the purpose of illustration and not limitation. It will be apparent to those skilled in the art that the embodiments described herein may be modified or revised in various ways without departing from the spirit and scope of the invention. The scope of the invention is to be measured by the appended claims.

What is claimed is:

1. A roll-to-roll continuous manufacturing process for producing a thermoplastic composite laminate comprising:
extruding a thermoplastic resin into a film article;
surface treating a woven fiber cloth material with a polymer sizing; and
laminating at least one layer of thermoplastic film and at least one layer of the surfaced treated fiber cloth material into a composite sheet at a temperature above the melting or softening point of the thermoplastic film and under pressure applied by nipping rolls or nipping belts.

2. The process according to claim 1 further including adding a silane coupling agent to the thermoplastic film.

3. The process according to claim 1 further including adding a silane coupling agent to the polymer sizing.

4. The process according to claim 1, wherein the extruding is by one selected from the group consisting of a blown film process and a flat-die process.

5. The process according to claim 1, wherein the thermoplastic resin is selected from the group consisting of thermoplastic polyurethane, polyethylene terephthalate glycol-modified copolyester, polycarbonate, poly(methyl methacrylate), polycarbonate/acrylonitrile butadiene styrene blend and polystyrene.

6. The process according to claim 1, wherein the thermoplastic resin is polyurethane.

7. The process according to claim 6, wherein the polyurethane has soft segments in its backbone structure and hardness between 50-80 Shore D.

8. The process according to claim 6, wherein the polyurethane has no soft segments in its backbone structure and has a hardness above 80 Shore D.

9. The process according to claim 1, wherein the polymer sizing is selected from the group consisting of polyurethane, epoxy, phenolic and polyacrylate based dispersion in water or an organic solvent.

10. The process according to claim 1, wherein the polymer sizing is a dispersion of polyurethane in water.

11. The process according to claim 1, wherein the fibers are selected from the group consisting of glass, rock, ceramic, carbon, graphite, polyamide, aramid, wool cotton, copper and aluminum and combinations thereof.

12. A thermoplastic composite laminate made according to the process of claim 1.

13. An article made of the thermoplastic laminate according to claim 12.
